(19) United States
(12) Patent Application Publication
(10) Pub. No.: US 2026/0208133 A1
(43) Pub. Date: Jul. 23, 2026

(54) MIXER DESIGN WITH REUSABLE MAGNET

(71) Applicant: Repligen Sweden AB, Lund (SE)

(72) Inventors: Alf Löfving, Mölndal (SE); Lennart Myhrberg, Mölndal (SE); Piriya Tangnavarad, Mölndal (SE); Gustav Larsson, Mölndal (SE); Joakim Ahlgren, Mölndal (SE); Håkan Törnqvist, Mölndal (SE); Erik Gerremo, Mölndal (SE)

(73) Assignee: Repligen Sweden AB, Waltham, MA (US)

(21) Appl. No.: 19/142,712

(22) PCT Filed: Dec. 22, 2023
(86) PCT No.: PCT/IB2023/063200

§ 371 Date: Jun. 24, 2025

Related U.S. Application Data
(60) Provisional application No. 63/477,958, filed on Dec. 30, 2022.

(51) Int. Cl. B01F 33/453; B01F 35/00

(52) U.S. Cl. CPC B01F 33/4533; B01F 35/165

(57) ABSTRACT

Embodiments of the present disclosure include a device for stirring that includes a magnetic material. The magnetic material is disposed within a housing (210), and the housing includes a cup and a cover. The housing encapsulates the magnetic material, and the magnetic material is non-rotatable within the housing. The device also includes an agitator (230) connected to at least a portion of the housing, the agitator including a sleeve and a plurality of vanes. The housing, magnetic material, and agitator are configured to selectively rotate about an axis of rotation. Embodiments of the present disclosure include a method for manufacturing a device for stirring. The method includes encapsulating a magnetic material in a housing, the housing including a cup and a cover. The method includes joining the cup and the cover with a mating connection. The method also includes overmolding an agitator over at least a portion of the housing, where the agitator covers the mating connection.

### CROSS-REFERENCE TO RELATED APPLICATIONS

This application claims the benefit of priority of U.S. Provisional Application No. 63/477,958, filed Dec. 30, 2022, which is incorporated herein by reference in its entirety.

### TECHNICAL FIELD

This disclosure generally relates to an assembly for agitating, stirring, or mixing material and, more particularly, to a single-use magnetic mixer assembly for agitating, stirring, or mixing material.

### BACKGROUND

In pharmaceutical manufacturing, or pharmaceutical production, mixers may be used to agitate and mix materials or components (e.g., pharmaceuticals, drugs, and/or other compounds in a formulation) until sufficiently blended. Different materials and formulations may have different requirements and often require different mixing methods. For example, a powder may be brought into liquid solution with or without other materials and with or without aeration. In another example, living cells that are typically sensitive to shear may require mixing and combination with other materials without damage. Additionally, some components may need variable mixing (e.g., a combination of two or more of low shear, high shear, vortex, and non-vortex mixing) in a single batch to provide satisfactory mixing and suitable end results. Furthermore, the materials and other substances may be heated or cooled, or include chemical or biological processing, during the mixing process. Generally, the quicker and more efficient a substance or compound is mixed into homogenous blend, the less time is required in the manufacturing process. This contributes to timely, efficient, and complete mixing.

Pharmaceuticals may be manufactured or produced by mixing material in batches using reusable mixing equipment or mixing material in batches using single-use mixing equipment. And in some pharmaceutical manufacturing processes, the mixing of materials may be accomplished using reusable technologies. For example, the mixing equipment (often made from stainless steel) may be designed to be durable for multiple uses and suitable for sterilization and cleaning protocols between uses. Reusable technologies typically require significant initial investment in materials and equipment in addition to costly cleaning and sterilization systems and protocols. Additionally, the likelihood of cross-contamination between uses exists when using reusable technologies, even between batches of the same end product.

In other pharmaceutical manufacturing processes, the mixing of materials may be accomplished using single-use technologies. The mixing equipment (made of any suitable material, including molded plastics) may be designed to be used once and discarded. Mixing equipment may be fabricated, sterilized, and assembled in a clean room environment prior to distribution and use. After use, the equipment may be cleaned and disposed of as waste. Using disposable, or single-use, equipment may result in lower initial investment and a more adaptive manufacturing process.

However, the process of disposing mixing equipment after a single use may introduce environmental or sustainability challenges.

The present disclosure is directed to overcoming one or more of the shortcomings mentioned above and/or other shortcomings in the art. For example, in an effort to support the manufacturing process over time or reduce the depletion of natural or physical resources, single-use equipment may be designed such that some or all the elements or components may be reused or recycled.

### SUMMARY

Embodiments of the present disclosure include a device for stirring that includes a magnetic material. The magnetic material is disposed within a housing, and the housing includes a cup and a cover. The housing encapsulates the magnetic material, and the magnetic material is non-rotatable within the housing. The device also includes an agitator connected to at least a portion of the housing, the agitator including a sleeve and a plurality of vanes. The housing, magnetic material, and agitator are configured to selectively rotate about an axis of rotation.

Embodiments of the present disclosure include a method for manufacturing a device for stirring. The method includes encapsulating a magnetic material in a housing, the housing including a cup and a cover. The method includes joining the cup and the cover with a mating connection. The method also includes overmolding an agitator over at least a portion of the housing, where the agitator covers the mating connection.

### BRIEF DESCRIPTION OF THE DRAWINGS

The accompanying drawings, which are incorporated in and constitute a part of this specification, illustrate disclosed embodiments and, together with the description, serve to explain the disclosed subject matter.

FIG. 1A illustrates an isometric view of a device for stirring, consistent with various embodiments of the present disclosure.

FIG. 1B illustrates a cross-section view of a device for stirring mounted on a stationary axle, consistent with various embodiments of the present disclosure.

FIG. 2 illustrates a cross-section of a device for stirring, consistent with various embodiments of the present disclosure.

FIG. 3A illustrates isometric views of a cup and a cover of a housing of a device for stirring, consistent with various embodiments of the present disclosure.

FIG. 3B illustrates a housing of a device for stirring, consistent with various embodiments of the present disclosure.

FIG. 4 illustrates an isometric view of a magnetic material of a device for stirring, consistent with various embodiments of the present disclosure.

FIG. 5 illustrates a detail view of a cross-section of a housing of a device for stirring, consistent with various embodiments of the present disclosure.

FIG. 6A depicts a breaking of a cup of a device for stirring, consistent with various embodiments of the present disclosure.

FIG. 6B depicts a removal of a magnetic material from a device for stirring, consistent with various embodiments of the present disclosure.

### DETAILED DESCRIPTION

Embodiments of the present disclosure generally relate to mixing equipment used in pharmaceutical manufacturing. Embodiments of the present disclosure relate to devices and methods for recycling and/or reusing components of single-use mixers, in particular, recycling or reusing magnets or magnetic materials in a mixing, stirring, or agitating device. Additionally, or alternatively, embodiments of the present disclosure may also be used to mix non-pharmaceutical materials.

Embodiments may include a device for stirring. A device for stirring may embody a pharmaceutical mixer, a chemical compound mixer, or any other apparatus for mixing materials. In some embodiments, the device for stirring may be used in pharmaceutical manufacturing to agitate, blend, or mix components of pharmaceuticals, drugs, and other compounds in a formulation.

The device for stirring may be a mixer. The mixer may include an agitator, and the agitator may include vanes or blades for mixing components of a desired solution or product, such as pharmaceuticals. The mixer may include a shaft, axle, or sleeve located at a central or center axis of the mixer about which the mixer rotates. Furthermore, a magnet or magnetic material may be disposed within a container, such as a housing, and the container may be made of multiple assembled components. In some embodiments, the magnet or magnetic material and container may have a generally ring shape extending about the center axis of the mixer.

The mixer may be mounted for rotation on a stationary shaft or axle and placed in a rigid, semi-rigid, or flexible mixing vessel. In some embodiments, the mixer may be magnetically driven by a drive system located outside the mixing vessel, and the mixer may be configured to rotate about its center axis to mix, or agitate, the components of the desired solution or product.

As described above, the device for stirring may include a magnet or magnetic material. The magnet or magnetic material may include one or more of iron, cobalt, nickel, and any other ferromagnetic element. In some embodiments, the magnet or magnetic material may have a generally ring shape extending about a central, or center, axis of rotation. Additionally, or alternatively, the magnet or magnetic material may include one or more projections. The one or more projections may be located on one or more faces of the magnetic material.

In some embodiments, the magnetic material may include a ferromagnetic element encapsulated by stainless steel or any other chemically inert, durable material, which may form a stainless steel shell. The stainless steel shell may be connected to the ferromagnetic element via a mechanical or chemical bonding method, such as welding. As described in more detail below, the ferromagnetic element may include one or more projections extending from an end face, the stainless steel shell may include one or more projections extending from an end face, or the ferromagnetic material and the stainless steel shell may include one or more projections extending from respective end faces. It is contemplated that the projections on the ferromagnetic material and the stainless steel shell may be complimentary, may be aligned, may be offset, or arranged in any suitable pattern.

Furthermore, it is contemplated that the ferromagnetic element may be categorized by grade. For example, if the magnetic material includes a stainless steel (or other material) shell, the ferromagnetic element may be a relatively higher grade material relative to the grade of the ferromagnetic element of a magnetic material that is not encapsulated by a stainless steel shell. The grade of a magnetic material may be indicative of purity, flux, durability, strength, or energy density of the ferromagnetic element. For example, a higher grade may indicate a stronger magnetic flux.

The magnetic material may be disposed within a housing. The housing may include two or more components that cooperate to cover or enclose the magnetic material. For example, the housing may include a cup and a cover. The cup and cover may be made of polymethyl methacrylate (PMMA), polycarbonate (PC), polyethylene (PE), polypropylene (PP), or any other suitable plastic material. In some embodiments, the cup may be made of the same material as the cover. In other embodiments, the cup may be made of a different material than the cover.

Additionally, or alternatively, the cup and cover may be configured such that the cup and cover may assemble via a mating connection to form the housing, where the connection may include a snap fit connection, a threaded connection, a press fit connection, or any other suitable mechanical or chemical connection for joining the cup or cover. It is contemplated that any suitable mating connection may be used to assemble the two or more components of the housing.

The housing may completely or fully enclose, or encapsulate, the magnetic material. For example, the magnetic material may be placed inside the cup and the cover may be placed over the magnetic material to form the housing. Alternatively, the magnetic material may be placed inside the cover and the cup may be placed over the magnetic material to form the housing. It is also contemplated that any sequence may be used to assemble the magnetic material within the housing. It is further contemplated that the magnetic material may be completely or fully enclosed by, or encapsulated by, the housing such that the magnetic material is not exposed to an environment outside or beyond the housing.

Furthermore, in some embodiments, the magnetic material may be in substantial contact with the interior surface of the housing, e.g., the interior surfaces of the cup and cover. In some embodiments, there may be one or more internal gaps between a portion of the magnetic material and a portion of the cup. For example, the magnetic material may include projections or flanges extending beyond a major surface of the material, e.g., extending beyond an end face of a ring element. The projections or flanges of the magnetic material may interact with the cup, or cover, or any component of the housing, such that one or more gaps may be formed between the magnetic material and an internal surface of the cup, or cover, or any component of the housing.

In some embodiments, one of the cup, cover, or any component of the housing, may include one or more grooves or other indents or detents. The one or more grooves may be located on one or more internal faces of the cup, cover, or any component of the housing, and be positioned adjacent the magnetic material. In some embodiments, the one or more grooves may each be the same relative shape and/or size. In other embodiments, the one or more grooves may be different relative shapes and/or sizes.

The one or more grooves of the cup portion may interact with, or engage, the one or more projections or flanges of the magnetic material. For example, the magnetic material may be non-rotatable within the housing due to the interaction between the one or more projections and the one or more grooves. It is further contemplated that the magnetic material may be held non-rotational to the housing in any suitable manner. In some embodiments, the one or more projections of the magnetic material and the one or more grooves of the cup may be configured to form one or more gaps between at least a portion of the magnetic material and at least a portion of the housing. The one or more gaps may provide, or define, a cutting groove configured to accommodate a blade or other cutting utensil and facilitate removal of a portion of the housing to expose the magnetic material contained therein.

In some embodiments, an agitator, e.g., a mixing head with vanes or blades, may be connected to at least a portion of the housing. In some embodiments, the agitator may be overmolded over the housing, with the magnetic material already disposed within the housing. The overmolding of the agitator over the housing may allow the magnetic material to be free of mechanical or chemical bonding to the agitator or any other component of the device for stirring, which may aid in separating the magnetic material from the agitator and reusing the magnetic material as described herein. In some embodiments, the agitator may be molded over the mating connection of the cup and cover of the housing or over one or more mating connections between two or more components of the housing. A portion of the housing, such as a portion of the cup, may be exposed to a mixing environment and not covered or molded over by a portion of the agitator. The housing, magnetic material, and agitator may be configured to selectively rotate about an axis of rotation as described in more detail below. The axis of rotation may be a center, or central, axis of the device for stirring.

Embodiments of the device for stirring may be fabricated, sterilized, and assembled in a clean room environment. Fabrication may include injection molding, blow molding, additive manufacturing techniques, or any other suitable manufacturing method. Processes for sterilizing the device for stirring may include gamma irradiation sterilization, steam sterilization, dry heat sterilization, ethylene oxide sterilization, or any other method of making the device for stirring free from bacteria and/or other living microorganisms. After fabrication, the device for stirring may be distributed for use. It is also contemplated that the device for stirring may be manufactured and sterilized post fabrication.

Some embodiments may include a method for manufacturing and assembling the device for stirring. The method may include assembling the magnetic material in the cup. The cover may be assembled on the cup to form the housing. The housing, including the magnetic material disposed within the housing, may be placed in a mold, and an agitator may be molded over the housing by an injection molding process. In other embodiments, the housing and an axle sleeve may be placed in the mold, and the agitator may be molded over the housing and the axle sleeve by the injection molding process. In some embodiments, the agitator may be overmolded over a portion of the housing but not the entire housing. In other embodiments, the agitator may be overmolded over the entire housing.

The assembled device for stirring may be placed in a carboy, a flexible bag vessel, a rigid or semi-flexible container, or any other mixing vessel. Materials or components to be mixed, stirred, or agitated may be placed in the mixing vessel. The assembled device for stirring may agitate and mix the materials or components to manufacture and produce a desired pharmaceutical product.

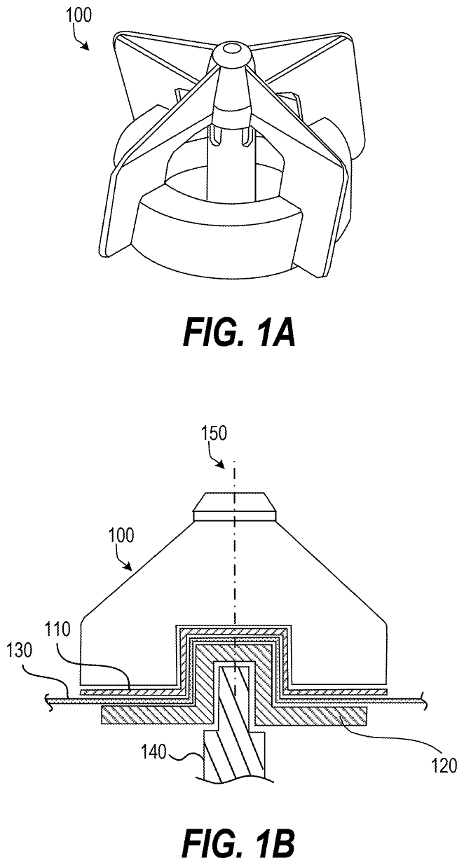

FIG. 1A illustrates a device for stirring, mixer 100, consistent with embodiments of the present disclosure. In some embodiments, mixer 100 may be a single-use mixing device designed for disposal after use. In other embodiments, mixer 100 may be a single-use mixing device where some components are designed to be disposed of after use and other components are designed to be reused in another mixer.

Mixer 100 may include any type of mixer suitable for mixing, agitating, or stirring material inside a mixing vessel. It is contemplated that mixer 100 may include one or more blades or vanes designed for any type of mixing. For example, as shown in FIG. 1, mixer 100 may include four blades. It is also contemplated that the one or more vanes or blades may have any shape. During use, mixer 100 may be configured to rotate about a center axis. Rotation of the mixer may be actuated by a magnetic drive mechanism, where the magnetic mechanism may include arranging one or more sets of magnets or magnetic materials such that they interact with each other and transmit force.

As shown in FIG. 1B, mixer 100 may be mounted on a stationary axle. The stationary axle, including bearing 110, may be disposed within a mixing vessel. In some embodiments, the mixing vessel may be a flexible bag 130. As shown in FIG. 1B, flexible bag 130 may interface with tank plate 120. For example, mixer 100, may be mounted on a stationary housing, and the stationary housing may include tank plate 120 and drive unit 140. The stationary housing may be configured to support and impart rotational motion to mixer 100. For example, drive unit 140 of the stationary housing may include one or more magnets that interact with a magnetic material disposed in mixer 100 such that rotation of the one or more magnets in drive unit 140 impart or cause rotation of the magnetic material in mixer 100 and thereby rotate mixer 100 about the stationary axle. The assembly may be configured to generate contactless transfer of rotation from drive unit 140 to mixer 100. In some embodiments, the first magnetic material and second magnetic material may be arranged symmetrically about a center axis 150 to generate magnetic force that actuates the rotation of mixer 100 while keeping radial forces between mixer 100 and the stationary axle at a minimum.

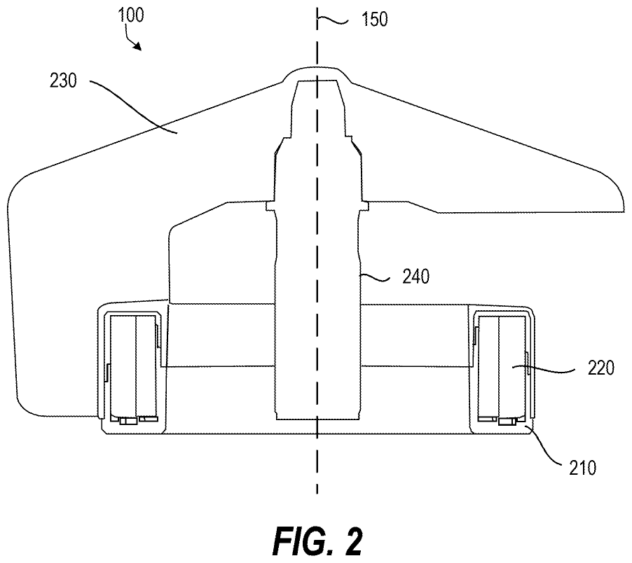

FIG. 2 illustrates a cross-section of mixer 100, consistent with embodiments of the present disclosure. Mixer 100 may include a housing 210, and magnetic material 220 may be disposed within housing 210. As shown in FIG. 2, magnetic material 220 may be completely or fully enclosed, or encapsulated, by housing 210.

Magnetic material 220 and housing 210 may be arranged circumferentially about the center axis of mixer 100. In some embodiments, magnetic material 220 may be a monobloc, or continuous, ring element, as shown in FIG. 2. That is, magnetic material 200 may be a single piece component. In other embodiments, magnetic material 220 may be a modular, or discontinuous, ring element. That is, magnetic material 220 may include one or more sub-elements or sub-components that together are arranged circumferentially about the center axis of mixer 100 in the general form of a ring. For example, magnetic material 220 as a modular ring element may include more than one pieces, or modules, of ferromagnetic material arranged in a ring shape.

Mixer 100 may be mounted on a stationary axle. Mixer 100 may include axle sleeve 240. Axle sleeve 240 may be metallic or any other suitable material. In some embodiments, axle sleeve 240 may include a radial bearing. The radial bearing of axle sleeve 240 may be configured to interact with a corresponding radial bearing on the stationary axle. Mixer 100 may be rotatably supported on axle sleeve 240 and driven by a drive shaft of a drive unit 140 (as shown in FIG. 1B) to agitate, mix, or stir material in a mixing vessel (e.g., a flexible bag 130, as shown in FIG. 1B).

Cup 260 and cover 270 may connect to one another by a mating connection 250. Mating connection 250 may be a snap fit connection, press fit connection, or threaded connection. In some embodiments, cup 260 and cover 270 may be connected to one another by glue, adhesive, tape, or by welding or soldering. It is contemplated that mating connection 250 may be any suitable type of mechanical or chemical connection. Cup 260 and cover 270 may assemble to completely or fully enclose, or encapsulate, magnetic material 220. In other embodiments, cup 260 and cover 270 may assemble to partially enclose magnetic material 220.

In some embodiments, agitator 230 may be partially molded over housing 210 (e.g., assembly of cup 260 and cover 270) such that a portion of housing 210 interfaces with the mixing environment. As shown in FIG. 2 and discussed above, magnetic material 220 may be encapsulated by housing 210. Housing 210 and agitator 230 may be connected via overmolding of agitator 230 while magnetic material 220 remains free from mechanical or chemical adhesion. This may allow the magnetic material 220 to be removed while minimizing damage to it and allow it to be reused.

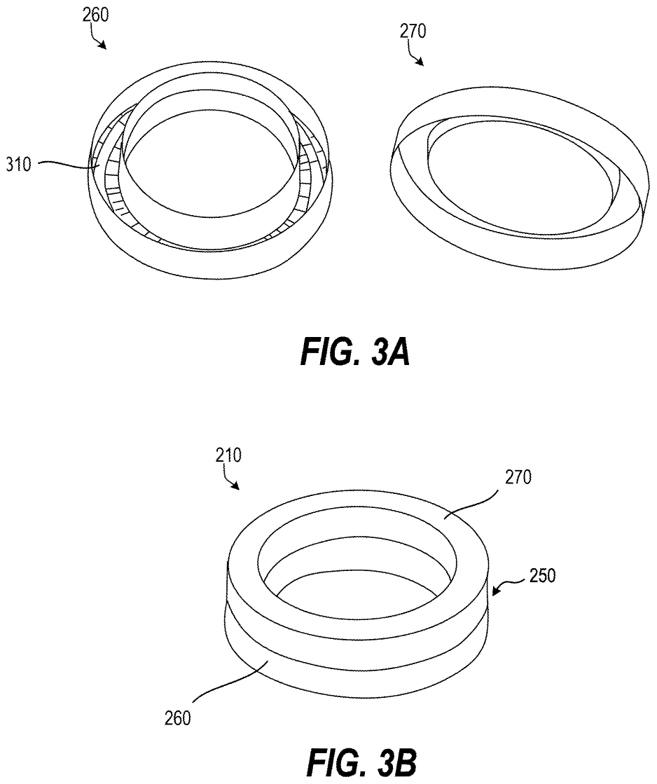

Furthermore, as shown in FIG. 2, agitator 230 may be partially molded over housing 210 such that agitator 230 covers mating connection 250 (shown in FIG. 3B), sealing housing 210 and, in particular, sealing mating connection 250.

Thus, magnetic material 220 may remain unexposed to various compounds during use. This may prevent contamination of magnetic material 220 and allow it to be reused. In other embodiments, agitator 230 may be molded over housing 210 such that housing 210 is completely or fully enclosed by, or encapsulated by, agitator 230.

FIG. 3A illustrates isometric views of cup 260 and cover 270 of housing 210, consistent with embodiments of the present disclosure. As shown in FIG. 3A, cup 260 and cover 270 may be ring shaped to be complementary to a ring shaped magnetic material (not shown). In other embodiments, cup 260 and cover 270 may be any shape or size complementary to the magnetic material. As shown in FIG. 3A, cup 260 may include one or more grooves 310 on an internal surface. Cup 260 may include one or more grooves 310 on one or more internal surfaces. One or more grooves 310 may be present on an entire face of an internal surface of cup 260, as shown in FIG. 3A. In other embodiments, one or more grooves 310 may be present on a portion of a face of the internal surface.

For example, one or more grooves 310 may be arranged circumferentially on the internal surface of cup 260. As shown in FIG. 3A, one or more grooves 310 may follow the arc of the circumference of the internal surface of cup 260. It is contemplated that one or more grooves 310 may be any suitable shape, such as, but not limited to, circular, triangular, trapezoidal, or hexagonal. In some embodiments, one or more grooves 310 may be of different sizes and shapes.

FIG. 3B illustrates housing 210, consistent with embodiments of the present disclosure. As shown, housing 210 is formed by assembling cup 260 and cover 270. As shown, cup 260 and cover 270 may be ring shaped and thus, housing 210 may be ring shaped. In some embodiments, the shape of housing 210 may be complementary to the shape of magnetic material 220.

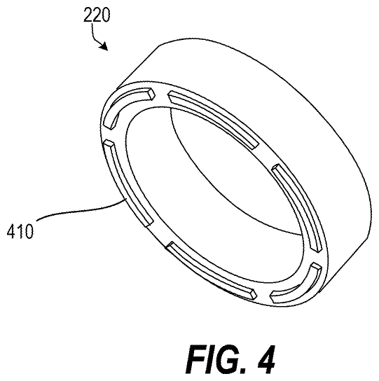

FIG. 4 illustrates an isometric view of a magnetic material 220, consistent with embodiments of the present disclosure. In some embodiments, and as shown in FIG. 4, magnetic material 220 may be ring or circumferentially shaped. In some embodiments, magnetic material 220 may be a monobloc, or continuous, ring element. Magnetic material 220 may include one or more projections 410. In some embodiments, one or more projections 410 may be arranged circumferentially on a surface, such as a face, of magnetic material 220. As shown in FIG. 4, one or more projections 410 may follow the arc of the circumference of a surface of magnetic material 220. It is contemplated that the one or more projections 410 may be any suitable shape, such as, but not limited to, circular, triangular, trapezoidal, or hexagonal. In some embodiments, one or more projections 410 may be of different sizes and shapes.

In some embodiments, one or more of projections 410 may be configured to fit within, or engage with, one or more of grooves 310 of cup 260. This may substantially prevent rotation of magnetic material 220 within cup 260 during use of mixer 100, i.e., when magnetically driven to rotate.

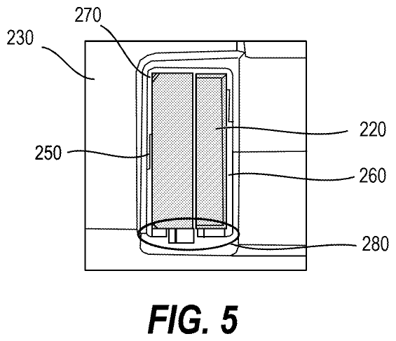

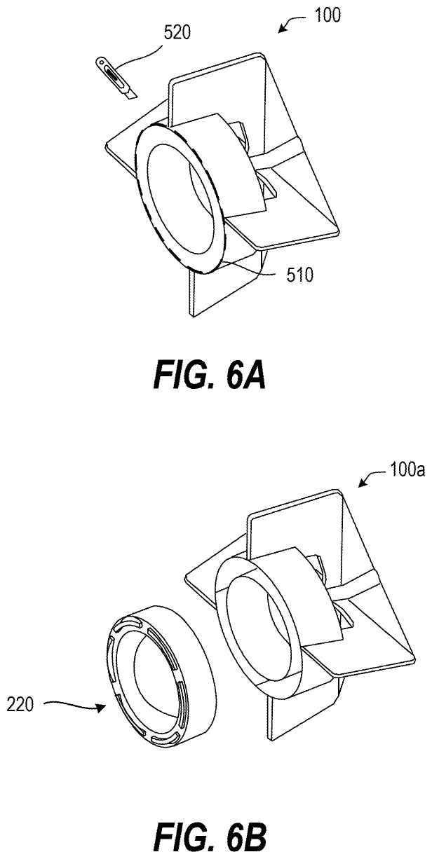

In some embodiments, one or more projections 410 may be larger than one or more grooves 310. This may create one or more gaps 280 between magnetic material 220 and cup 260 when magnetic material 220 is disposed within cup 260, as shown in FIG. 5. For example, one or more projections 410 may have a dimension, e.g., an axial dimension, that is larger than a dimension, e.g., an axial dimension, of the one or more grooves 310. That is, one or more projections 410 may be configured to fit within one or more grooves 310 and be seated within one or more grooves 310 and also extend beyond the open end of one or more grooves 310. This may create one or more gaps 280 between the face of magnetic material 220 on which one or projections 410 are located and an internal face or surface of cup 260. As shown in FIG. 5, one or more gaps 280 may provide a cutting groove configured to accommodate a blade or other cutting utensil and facilitate removal of a portion of cup 260 of housing 210 to expose magnetic material 220. For example, as shown in FIGS. 6A-6B, a blade or cutting utensil 520 may be used to cut the outer perimeter or inner perimeter at or near surface 510 of cup 260. The one or more gaps may allow the blade or cutting utensil 520 to cut into cup 260 while reducing the risk of touching, or damaging, the magnetic material disposed within the housing.

After use, the device for stirring may be cleaned and disposed of as waste. Additionally, or alternatively, components of mixer 100 may be recycled or reused. Furthermore, some components of a device for stirring may be designed for reuse while other components of mixer 100 may be designed for recycling or disposal after use. For example, the cup, cover, and agitator may be designed to be disposed of or recycled after use and the magnetic material may be designed to be reused in another device for stirring.

A device for stirring may be evaluated for recycling or reuse. A used device for stirring may be classified based on exposure during use and an estimated risk of remaining biohazards load. For example, a used device for stirring may be classified based on a low biohazards load, a moderate biohazards load, and a critical biohazards load. While three classifications are described, it is contemplated that any number of classifications may be utilized for evaluating whether the device for stirring, or components thereof, will be or can be recycled or reused. A used device for stirring classified as low may be prescribed a first type of cleaning and decontamination and considered a candidate for recycling and reuse of some components. A used device for stirring classified as moderate may be prescribed a second, more intensive, type of cleaning and decontamination and considered a candidate for recycling and reuse of some components. A used device for stirring classified as critical may not be considered a candidate for recycling or reuse and instead be prescribed for disposal via incineration or as waste.

In some embodiments, a course of action for disposal may be determined or prescribed and performed based on the classification of remaining biohazards load. A course of action based on a low biohazards load may include sterilizing the used device for stirring, removing and reusing the magnetic material, and recycling or otherwise disposing of the remaining components. A course of action based on a moderate biohazards load may include sterilizing the used device for stirring, removing and reusing the magnetic material, and recycling or otherwise disposing of the remaining components. It is contemplated that any suitable sterilization may be used and may be determined based on the assessed risk of biohazard load. For example, the after-use sterilization for a used device classified as a moderate biohazard load may undergo a more stringent sterilization than the after-use sterilization for a used device classified as a low biohazard load. A course of action based on a critical biohazards load may include sterilizing the used device for stirring and destroying the used device for stirring.

The present disclosure also includes a method for manufacturing and recycling a device for stirring. As discussed above, a device for stirring may be manufactured by arranging a magnetic material in a cup 260. A cover 270 may be assembled with cup 260, and the cup 260 and cover 270 assembly may form a housing 210 encapsulating the magnetic material. An agitator including vanes or blades for mixing material may be connected to the housing. For example, the housing, including the encapsulated magnetic material, may be placed in a mold and an agitator may be overmolded around some or all of the housing. In addition, a sleeve, shaft, or axle may also be placed in the mold along with the housing, including the magnetic material, and an agitator may be overmolded around some or all of the housing and the sleeve, shaft, or axle.

The device for stirring may be manufactured in a sterile environment, e.g., a clean room, or be sterilized after manufacture and distributed for use. During use, the device for stirring may be mounted on a stationary shaft and placed in a rigid, semi-rigid, or flexible mixing vessel. Materials, or components to be mixed, may be placed in the mixing vessel and the device for stirring may be actuated, or magnetically driven, by a drive system located outside the mixing vessel to mix or agitate the material.

After use, that is, after the device was used to mix or agitate material, classified as a candidate for recycling and reuse, and sterilized, the cup 260 of the housing 210 of the device for stirring may be broken to provide access to the magnetic material 220 and the interior of the housing 210. Breaking may include cutting, e.g., with a blade or other cutting utensil 520 as illustrated in FIG. 6A. It is contemplated that breaking may include any action that results in the cup 260 being separated into two or more pieces.

After opening the housing, and as shown in FIG. 6B, the magnetic material 220 may be removed. Because the magnetic material 220 was fully encapsulated within the housing 210, it may remain unexposed to contaminants during and after use. Additionally, because a used device may be sterilized after use, yet sterilized before the housing is opened, the magnetic material 220 may remain unexposed to contaminants during and after use. Magnetic material 220 remaining unexposed to contaminants during and after use may reduce a risk of cross-contamination and permit reuse of the magnetic material 220 from a used device to a new device.

As discussed above, one or more grooves 310 and one or more projections 410 may interact to create one or more gaps 280 between the face of magnetic material 220 and an internal face or surface 510. For example, one or more projections 410 may be disposed circumferentially in the middle of a surface of magnetic material 220. One or more projections 410 may interact with one or more grooves 310 such that one or more gaps 280 are created circumferentially around the outside of one or more projections 410 and circumferentially around the inside of one or more projections 410. Thus, cutting utensil 520 may be used to cut at an outer perimeter of cup 260, as shown in FIG. 6A. In some embodiments, cutting utensil 520 may be used to cut at an inner perimeter of cup 260. In other embodiments, cutting utensil 520 may cut at an outer perimeter and an inner perimeter of cup 260. As shown in FIG. 6B, a surface 510 of cup 260 may be removed from broken mixer 100a, exposing magnetic material 220. Magnetic material 220 may be removed from broken housing 100a, as shown.

Embodiments of the present disclosure may include manufacturing a second device for stirring using the same magnetic material as was used previously. It is contemplated that any number of devices for stirring may be manufactured using the same magnetic material. A second device for stirring may include a pharmaceutical mixer, a chemical compound mixer, or any other apparatus for mixing compounds. In some embodiments, a second device for stirring may be used in pharmaceutical manufacturing to blend components of pharmaceuticals, drugs, and other compounds in a formulation. In some embodiments, a second device for stirring may be the same type of device as a first device for stirring. In other embodiments of the present disclosure, a second device for stirring may be a different type of device than a first device for stirring, where the magnetic material is removed from a first device for stirring and used to manufacture a second device for stirring. That is, the second device may include the same or different number of blades or vanes than the first device. Similarly, the shape of the blades or vanes of the second device may be the same or different than the shape of the blades or vanes of the first device.

Manufacturing a second device for stirring may include placing the same magnetic material as was removed from a first (used) device for stirring in a second cup. The second device for stirring may be manufactured and assembled in the same or a similar manner as previously described.

While illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

Other embodiments will be apparent from consideration of the specification and practice of the embodiments disclosed herein. It is intended that the specification and examples be considered as example only, with a true scope and spirit of the disclosed embodiments being indicated by the following claims.

1. A device for stirring comprising:
a magnetic material disposed within a housing, the housing including a cup and a cover, the housing encapsulating the magnetic material, wherein the magnetic material is non-rotatable within the housing; and wherein one or more grooves and one or more projections interact to create one or more gaps between a face of the magnetic material and an internal face of the housing; and
an agitator connected to at least a portion of the housing, the agitator including a sleeve and a plurality of vanes, wherein the housing, the magnetic material, and the agitator are configured to selectively rotate about an axis of rotation.

2. The device for stirring of claim 1, wherein the agitator is molded over at least a portion of the housing.

3-6. (canceled)

7. The device for stirring of claim 1, wherein the cup includes the one or more grooves and the magnetic material includes the one or more projections.

8. The device for stirring of claim 7, wherein the one or more projections of the magnetic material engage the one or more grooves of the cup of the housing.

9. (canceled)

10. The device for stirring of claim 8, wherein the one or more gaps define a cutting groove configured to accommodate a cutting utensil and facilitate removal of a portion of the cup of the housing to expose the magnetic material.

11. A method for manufacturing a device for stirring, the method comprising:
encapsulating a magnetic material in a housing, the housing including a cup and a cover;
joining the cup and the cover with a mating connection; wherein one or more grooves and one or more projections interact to create one or more gaps between a face of the magnetic material and an internal face of the housing; and
overmolding an agitator over at least a portion of the housing, wherein the agitator covers the mating connection.

12-14. (canceled)

15. The method of claim 11, wherein the cup includes the one or more grooves and the magnetic material includes the one or more projections.

16. The method of claim 15, further including fitting the one or more projections of the magnetic material within the one or more grooves of the cup.

17-19. (canceled)

20. The method of claim 11, further including breaking the cup of the housing adjacent the one or more gaps, removing the portion of the cup of the housing to expose the magnetic material, and removing the magnetic material from the housing.

21-25. (canceled)

26. The method of claim 11, further including:
encapsulating the magnetic material in a second housing, the second housing including a second cup and a second cover;
joining the second cup and the second cover with a second mating connection; and
overmolding a second agitator over at least a portion of the second housing, wherein the second agitator covers the second mating connection.

27. (canceled)

28. The method of claim 26, wherein the second housing includes one or more gaps between a portion of the magnetic material and a portion of the second cup.

29. The method of claim 26, wherein the second cup includes one or more grooves.

30. The method of claim 29, further including fitting the one or more projections of the magnetic material within the one or more grooves of the second cup.

31. The method of claim 30, wherein the one or more projections of the magnetic material and the one or more grooves of the second cup of the second housing are configured to form one or more gaps between a portion of the magnetic material and a portion of the second cup.

32-37. (canceled)

38. A magnetic component for use in a device for stirring, the magnetic component comprising:
a magnetic material disposed within a housing, the housing including a cup and a cover, the housing encapsulating the magnetic material, wherein the magnetic material is non-rotatable within the housing; and wherein one or more grooves and one or more projections interact to create one or more gaps between a face of the magnetic material and an internal face of the housing.

39. The magnetic component of claim 38, wherein the cup includes the one or more grooves and the magnetic material includes the one or more projections.

40. The magnetic component of claim 39, wherein the one or more projections of the magnetic material engage the one or more grooves of the cup of the housing.

41. The magnetic component of claim 38, wherein the one or more gaps define a cutting groove configured to accommodate a cutting utensil and facilitate removal of a portion of the cup of the housing to expose the magnetic material.
